(19) United States
(12) Patent Application Publication
(10) Pub. No.: US 2003/0218445 A1
(43) Pub. Date: Nov. 27, 2003

(54) Portable electronic device carrier and charger

(76) Inventor: Brad M. Behar, Mineola, NY (US)

Correspondence Address: Brad M. Behar, 11 Shortridge Drive, Mineola, NY, 11501, US

(21) Appl. No.: 10/155,714

(22) Filed: May 21, 2002

(51) Int. Cl. H02J 7/00

(52) U.S. Cl. 320/114

(57) ABSTRACT

The present invention is a portable carrier and charger for a handheld, portable, electronic device with a rechargeable battery, such as a cellular phone, that alleviates the need to travel with a separate charger. The invention also includes a handheld, portable, electronic device with a rechargeable battery, such as a cellular phone, and a carrier and charger for the electronic device. In one embodiment of the invention, the portable carrier and charger can be attached to a belt or to clothes or the like.

The present invention is a portable carrier for a portable, handheld, electronic device with a rechargeable battery, such as a cellular phone, that also functions as a charger for the electronic device's battery. The present invention is also a portable, handheld, electronic device with a rechargeable battery and a portable carrier and charger for carrying the electronic device wherein the two items together comprise the necessary components for charging the electronic device's batteries.

### BACKGROUND OF THE INVENTION

Ownership of portable, handheld, electronic devices with rechargeable batteries such as cellular phones, personal digital assistants, organizers, and daily planners are common. People routinely carry one such electronic device with them if not more than one. Since the batteries in these electronic devices are rechargeable, people frequently need chargers for these electronic devices. Carrying and/or packing an existing charger or multiple chargers when traveling is inconvenient and cumbersome. If someone needs to recharge the dying battery in their electronic device and they do not have a charger with them, the user has a dilemma.

One example of such an electronic device is a cellular phone. The use of cellular phones has become so convenient that people carry them everywhere they go. Some people even use a cellular phone as their home telephone instead of an old-fashioned landline.

With electronic miniaturization, cellular phones are becoming increasingly lighter and smaller. The amount of power used by cellular phones is being minimized and batteries for cellular phones are becoming smaller. Smaller batteries provide for lighter and smaller cellular phones. The technology for rechargeable batteries is also improving and the batteries themselves are now lighter and lasting longer. At this point in time, however, the battery in a cellular phone cannot last forever. It requires recharging after a certain period of use depending upon many factors including the power demand selected by the user.

A conventional cellular phone battery charger required the user to remove the battery from the cellular phone and place it in a separate cradle that rested upon a desk or table. The charger included a plug assembly with an AC/DC adapter in it at one end of a chord to convert an alternating power supply into direct voltage and direct current. The other end of the chord was connected to the cradle. The battery would charge when the plug assembly was plugged in and the battery was in the cradle.

The next generation charger enabled the user to place the battery in the charger with the cellular phone attached. This allowed the user to keep the cellular phone powered while the battery charged.

Currently, a charger for a cellular phone typically includes some type of AC/DC adapter assembly in the shape of a box or cube with a plug. This is the part of the charger that gets plugged into an outlet and converts the alternating power into direct current and voltage. The charger also has a chord that attaches to the AC/DC adapter assembly at one end. The other end of the chord includes an attachment terminal to connect the charger to the charger terminal on the cellular phone. This type of charger requires that the user plug the charger into a receptacle, such as a standard wall outlet, connect the other end of the chord to the charger terminal on the cellular phone and then place the cellular phone down in the vicinity of the outlet.

Another type of charger for a cellular phone is a cradle for a desktop. For this type of charger, the user places the cellular phone in the cradle and a plug with AC/DC adapter circuitry located at the other end of a chord is plugged into an outlet.

One drawback to the above-mentioned types of chargers is that the wire typically gets in the way of the user or other things such as papers on a desk. Another drawback is that the cord is not aesthetically appealing, especially at an office or in a house. Yet another drawback to this type of charger is the user must carry it with them, separate from the phone, when traveling in order to be able to recharge the battery in their cellular phone. Even if an individual remembers or thinks to bring a charger with them, carrying and/or traveling with these types of chargers is inconvenient and cumbersome given their sizes and configurations. Consequently, people often leave their charger at home or they purchase multiple chargers to keep at multiple locations. It is not uncommon to hear about someone asking for a charger for their cellular phone when visiting someone else's office, or at a hotel, or at someone else's home, or when traveling elsewhere, because they did not bring their charger and their battery is dying or is dead.

It is also common for cellular phone users to own a separate carry case or “clip” for their cellular phones. A carry case or clip is made to hold a cellular phone when it is not in use and it is usually capable of attaching to something so that the user's hands are free to hold or do other things. A carry case or clip is typically made to attach to a belt or strap but it can also function as just a cradle. People sometimes place their cellular phones in carry cases or clips and then place the two in a briefcase, bag, pocket, pocket book, or on the seat of their car.

Some of the carry cases or clips now known and available on the market require the user to separate the cellular phone from the carry case or clip before a charger is connected to the cellular phone. For these carry cases and chargers, the user needs to keep track of the carry case or clip when the cellular phone's battery is charging. The carry case or clip is often misplaced when it is separated from the cellular phone.

Other patents have addressed some of the drawbacks and disadvantages relating to cellular phone batteries and chargers. For example, U.S. Pat. No. 6,191,553 to Feng-Jung (“Portable Charger with a Separate Base and Mount with a Belt Clip Attachment”) discloses an improved cellular phone battery charger that is portable and possesses a concealed plug. The charger includes an attaching mount so that the user can carry the charger on their belt separate from the cellular phone for removal when needed. The invention of the Feng-Jung patent thereby provides for less burdensome transport of the charger for the user but requires the battery to be removed from the phone before charging and does not alleviate the need to carry the charger separate from the cellular phone and it's carry case or clip.

U.S. Pat. No. 6,043,626 to Snyder et al. (“Auxiliary Battery Holder with Multicharger Functionality”) discloses a portable holder for a phone that recharges the phone's battery while it is in the carrier. The power supplied to the phone's battery comes form an auxiliary battery in the holder. When the phone is in the holder the auxiliary battery charges the phone's battery. When the charge of the auxiliary battery diminishes, the Snyder invention requires recharging of the auxiliary battery and the phone's battery with another charger. The user is still required to carry another charger device to repeatedly recharge the phone's battery.

The present invention alleviates some of the inconveniences and shortcomings of these devices and provides a portable apparatus that performs the function of both a carry case or clip and a charger. The portable apparatus functions as both a carrier and charger for a portable, handheld electronic device with a rechargeable battery, such as a cellular phone. The portable apparatus alleviates the need for two separate accessories, namely a carrier and a charger.

The present invention is also a portable apparatus for carrying a portable, handheld, electronic device with a rechargeable battery, such as a cellular phone, and an electronic device. When the electronic device is in the portable apparatus, the electronic device can be charged without the need for a separate charger.

### SUMMARY OF THE INVENTION

An object of the present invention is to provide a portable apparatus that is capable of functioning as both a carrier and a charger for a portable, handheld electronic device with a rechargeable battery, such as a cellular phone.

Another object of the invention is provide a portable electronic device with a rechargeable battery, such as a cellular phone, and a portable apparatus for carrying the electronic device, that when attached to each other and plugged into an outlet, are capable of charging the battery in the electronic device.

Yet another object of the invention is to alleviate the need to carry and transport a battery charger separate from, and in addition to, a portable, handheld electronic device with a rechargeable battery, such as a cellular phone, and its carry case or clip.

Still another object of the invention is to provide a convenient way to travel with a charger for a portable, handheld electronic device with a rechargeable battery, such as a cellular phone.

Another object of the invention is to provide a portable apparatus that can function as a chordless charger for a portable, handheld, electronic device with a rechargeable a battery, such as a cellular phone.

Yet another object of the present invention is to provide a portable apparatus for carrying a portable, handheld, electronic device with a rechargeable battery, such as a cellular phone, that can attach to clothing accessories and that can also plug into an outlet receptacle to charge the electronic device's battery.

It is yet another object of the present invention to provide an improved carry case or carry clip for a portable, handheld, electronic device with a rechargeable battery, such as a cellular phone, as well as an improved electronic device, that alleviates the need for a separate charger.

Another object of the invention is to provide a portable charger for a portable, handheld, electronic device with a rechargeable battery, such as a cellular phone, that is conveniently carried by a user and which does not add weight to the electronic device itself.

According to one aspect of the present invention, the portable carrier and charger can serve two useful purposes. First, the apparatus is capable of holding a portable, handheld, electronic device with a rechargeable battery, such as a cellular phone. Second, when the user wants to charge or recharge the battery of the electronic device, the user plugs the portable carrier and charger into an outlet and the battery in the electronic device charges without having to carry, locate or attach a separate charger. The user conveniently carries the charger with them in the same device they are using to carry the cellular phone.

One embodiment of the invention is a portable carrier and charger comprising a housing capable of holding a portable, handheld, electronic device with a rechargeable battery, such as a cellular phone, a plug attached to the housing, AC/DC adapter circuitry within the housing and a carrier terminal on the housing. Optionally, an attachment device can also be attached to the housing.

The housing can be made in many configurations to accommodate varying shapes and sizes of electronic devices. The housing is configured to hold the electronic device when the user places the electronic device in the housing. A plug is attached to the housing and the plug is connected to AC/DC adapter circuitry within the housing by electrically conductive material. The AC/DC adapter circuitry is connected to a carrier terminal that is attached to the housing, by electrically conductive material. The carrier terminal comprises metal contacts or pins or a board type connector with metal contacts. The carrier terminal is configured to connect to a charger terminal for charging the battery in the electronic device when the electronic device is placed in the housing of the portable carrier and charger.

An electronic device, such as a cellular phone, is placed in the portable carrier and charger to carry the electronic device. The portable carrier and charger and the electronic device can be carried in a pocket, bag, pocketbook, briefcase or the like. If the portable carrier and charger includes an attachment device, the portable carrier and charger and the electronic device therein, can be attached to things such as, for example, one's pants belt.

When the user wants to charge the battery in the electronic device, the plug on the housing of the portable carrier and charger is inserted into an outlet. Current then flows through the plug to the AC/DC adapter circuitry in the housing which converts the alternating voltage and the alternating current into direct voltage and direct current. The direct current then flows to the carrier terminal on the housing and to the charger terminal on the electronic device for charging the electronic device's battery.

Another embodiment of the invention is a portable, handheld, electronic device with a rechargeable battery, such as a cellular phone, and a portable carrier and charger. The electronic device comprises a rechargeable battery and a charger terminal connected to the battery by electrically conductive material. A direct power source is applied to the charger terminal to charge the battery in the electronic device.

The portable carrier and charger comprises a housing capable of holding the electronic device, a plug attached to the housing, AC/DC adapter circuitry within the housing and a carrier terminal on the housing. Optionally, an attachment device can also be attached to the housing.

The housing is configured to hold the electronic device when the user places the electronic device in the housing. A plug is attached to the housing and the plug is connected to AC/DC adapter circuitry within the housing by electrically conductive material. The AC/DC adapter circuitry is connected to a carrier terminal that is attached to the housing, by electrically conductive material. The carrier terminal comprises metal contacts or pins or a board type connector with metal contacts. The carrier terminal is configured to connect to the charger terminal on the electronic device for charging the battery in the electronic device when the electronic device is placed in the housing of the portable carrier and charger.

The electronic device, such as a cellular phone, is placed in the portable carrier and charger to carry the electronic device. The portable carrier and charger and the electronic device together can be carried in a pocket, bag, pocketbook, briefcase or the like. If the portable carrier and charger includes an attachment device, the carrier and charger and the electronic device therein, can be attached to things such as, for example, one's pants belt.

When the user wants to charge the battery in the electronic device, the plug on the housing of the portable carrier and charger is inserted into an outlet. Current then flows through the plug to the AC/DC adapter circuitry in the housing which converts the alternating voltage and the alternating current into direct voltage and direct current. The direct current then flows to the carrier terminal on the housing and to the charger terminal on the electronic device for charging the electronic device's battery.

### DESCRIPTION OF THE DRAWINGS

For the purpose of illustrating the invention, representative embodiments are shown in the accompanying figures, it being understood that the invention is not intended to be limited to the precise arrangements and instrumentalities shown.

FIG. 1 is a perspective view of the front of a portable carrier and charger according to one embodiment of the invention.

FIG. 2 is a perspective view of the back of the portable carrier and charger in FIG. 1.

FIG. 3 is a side view of a portable carrier and charger according to another embodiment of the invention.

FIG. 4 is a front view of the portable carrier and charger shown in FIG. 3.

FIG. 5 is a rear view of the portable carrier and charger shown in FIG. 3.

FIG. 6 is a side view of a portable, handheld, cellular phone with a rechargeable battery and a portable carrier and charger according to another embodiment of the invention.

FIG. 7 is a front view of the portable carrier and charger shown in FIG. 6.

FIG. 8 is a rear view of the portable carrier and charger shown in FIG. 6.

FIG. 9 is a front view of the cellular phone in FIG. 6.

FIG. 10 is a side view of a portable carrier and charger according to another embodiment of the invention.

FIG. 11 is a perspective view of the front of a portable carrier and charger shown in FIG. 10.

FIG. 12 is a top view of a carrier terminal of the portable carrier and charger shown in FIG. 11.

FIG. 13 is a perspective view of the back of the portable carrier and charger shown in FIG. 10.

FIG. 14 is a perspective view of the front of a portable, handheld, cellular phone with a rechargeable battery for the portable carrier and charger shown in FIG. 10.

FIG. 15 is a bottom view of the cellular phone shown in FIG. 14.

FIG. 16 is a perspective view of the front of a portable, handheld, cellular phone for another embodiment of the invention.

FIG. 17 is a perspective view of the back of the cellular phone shown in FIG. 16.

FIG. 18 is a perspective view of the front of the portable carrier and charger for the cellular phone shown in FIG. 16.

### DETAILED DISCLOSURE OF THE INVENTION

Those skilled in the art will readily appreciate that the present invention is applicable to portable, handheld, electronic devices with rechargeable batteries including but not limited to, cellular phones, personal digital assistants, organizers, daily planners and devices capable of combining some or all of the functions of these devices. For purposes of illustration, and not limitation, the following detailed disclosure provides examples that illustrate the present invention for cellular phones.

One embodiment of the present invention is a portable carrier and charger for a portable, handheld, electronic device with a rechargeable battery. The portable carrier and charger comprises a housing configured to hold the electronic device when it is inserted by the user, a plug attached to the housing, AC/DC adapter circuitry within the housing and connected to the plug by electrically conductive material, and a carrier terminal on the housing connected to the AC/DC adapter circuitry by electrically conductive material.

The housing of the portable carrier and charger can be made from one or more materials that are capable of being constructed into a configuration for holding an electronic device. Such materials are known in the art and include, but are not limited to plastics, metals, fiberglass, composites, or combinations thereof. Since the AC/DC adapter circuitry is located in the housing, manufacture of the portable carrier and charger is easier when the housing comprises at least two pieces that can be securely fastened together after assembly of the electronics within the housing. For example, the housing can be made from two pieces of plastic that are held together by, for example, tabs, adhesive or screws. Preferably, the materials of construction for the housing are selected to minimize the weight of the carrier and charger.

The configuration of the housing is variable since portable, handheld, electronic devices with rechargeable batteries come in many sizes and shapes. Configurations capable of holding electronic devices such as, for example, cellular phones, personal digital assistants, organizers, daily planners and devices capable of combining some or all of the functions of these devices, are included. For example, the housing can be a shape where a specific electronic device slides into the housing and stays snugly in it until the user removes it. Alternatively, for example, the housing comprises tabs that fit into slots or openings in an electronic device when it is inserted into the housing.

The plug on the housing of the portable carrier and charger can be a standard three-prong plug that is fixedly attached to and stationary on the housing or the plug can be moveable within the housing. A two-prong plug is preferred because it is more universal for power supplies. A moveable two-prong plug is even more preferable, because it consumes less space when the plug is not needed and is concealable within the housing when not being used. Examples of moveable plugs include those capable of pivoting, rotating or sliding, or combinations thereof, into and out of the housing.

The plug is configured to fit into a standard outlet receptacle in a building (for example, in a home, an office, or hotel). The configuration of the plug is also variable for different power supplies.

The plug is connected to the AC/DC adapter circuitry in the housing by electrically conductive material. When the plug is inserted into a standard outlet receptacle with an alternating power supply, alternating current flows through the plug and the electrically conductive material to the AC/DC adapter circuitry in the housing. The electrically conductive material can one or more of many types of materials known in the art including but limited to wires, metal contacts, and screws.

The plug is composed of conductive material such as a metal (for example, copper or brass) and is connected to AC/DC adapter circuitry by electrically conductive material. When the plug is inserted into an outlet, current flows through the plug and the connecting electrically conductive material to the AC/DC adapter circuitry. One skilled in the art might consider the electronically conductive material as part of the AC/DC adapter circuitry.

The location of the plug on the housing is variable and can be chosen to minimize the size of the portable charger and carrier or for convenience when the plug is used. The plug can be located on any side of the housing.

When the plug is moveable within the housing it is preferably concealed in the housing when it not needed. Thus, before inserting the plug into an outlet, the user must first move (for example, rotate, pivot, and/or slide) the plug so that it protracts out of the housing.

The current and voltage required to charge a battery in a portable, handheld electronic device typically varies from one device to another. The portable carrier and charger of the present invention includes AC/DC adapter circuitry that is capable of supplying the necessary power for any one portable, handheld, electronic device.

The AC/DC adapter circuitry converts an alternating voltage and alternating current at a supplied frequency into direct voltage and direct current. The direct current then flows through electrically conductive material to the carrier terminal on the housing.

For example, the AC/DC adapter circuitry can be configured to convert approximately 100-240 volts AC and 0.02 amperes at 50-60 hertz to 4.4 volts DC and 1.1 amperes. AC adapters or AC/DC power supplies with AC/DC adapter circuitry capable of different output voltages and currents are well known in the art and are included herein.

The carrier terminal comprises electrically conductive material such as, for example metal contacts, metal pins or a board with electrically conductive contacts. The carrier terminal is configured to be in a location and to be a type of terminal that will connect with a charger terminal on a portable, handheld, electronic device with a rechargeable battery when it is inserted into the housing. For example, the carrier terminal can be one or more copper contacts that align with, and make contact with, the one or more copper contacts on a charger terminal on an electronic device. The carrier terminal and the charger terminal must be compatible and capable of conducting electricity between each other.

Alternatively, the carrier terminal can be a metal pin that gets inserted into a hole in a charger terminal of an electronic device that is configured to receive a metal pin. Similarly, the carrier terminal can be configured to be the receiving hole with metal therein for receiving a metal pin from a charger terminal on an electronic device.

More preferably, the carrier terminal is a series of small metal contacts or pins on a board. This type of carrier terminal is configured to fit into a similarly configured charger terminal on an electronic device with a slot containing metal contacts or pins. When the carrier terminal is inserted into the slot in the charger terminal, the conductive path between the two is established.

The carrier terminal can also be a slot-type connector containing metal contacts or pins that receives a charger terminal comprising a board with metal contacts.

The carrier terminal is configured to connect to a charger terminal on a portable handheld, electronic device with a rechargeable battery such that an electrically conductive path is created between the carrier terminal and a charger terminal in an electronic device. When the portable carrier and charger is inserted into an outlet, the direct current from the AC/DC adapter flows to the carrier terminal and the connecting charger terminal and then to the electronic device's battery for charging.

Optionally, the portable carrier and charger comprises an attachment device. The attachment device is, for example, a clip, strap, buckle, magnet, velcro, spring, slot, knob, combination thereof or other device known in the art for securing a carry case for a portable, handheld, electronic device to items such as clothing (for example, a pants pocket, a shirt or sweater lining or pocket, or a jacket pocket or lining) or clothing accessories (for example, a belt, a tie, a briefcase, a bag or a purse). The attachment device is configured to allow the user to carry the portable carrier and charger on their person (for example, on their belt, on their pant's pocket or on the strap of a bag or briefcase) without having to hold it in their hands. The attachment device can be fixedly attached to the housing or it can be removable from the housing.

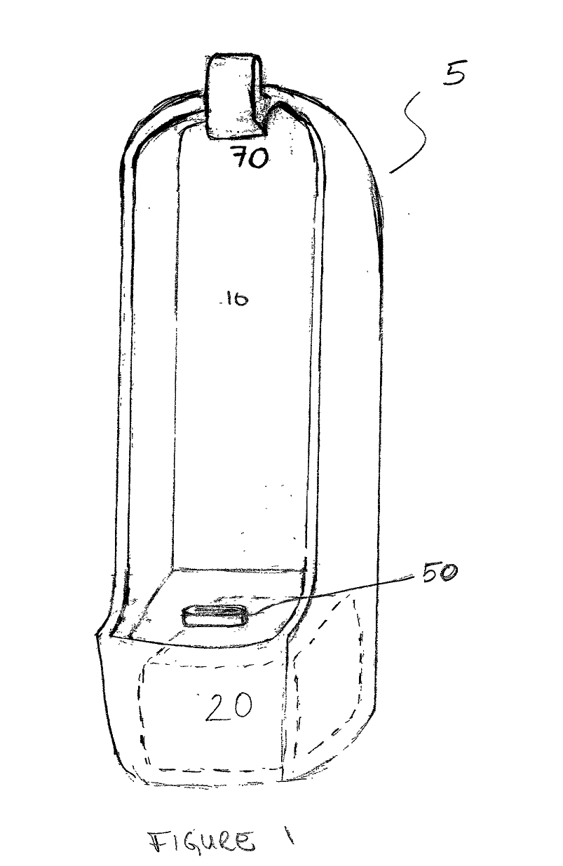

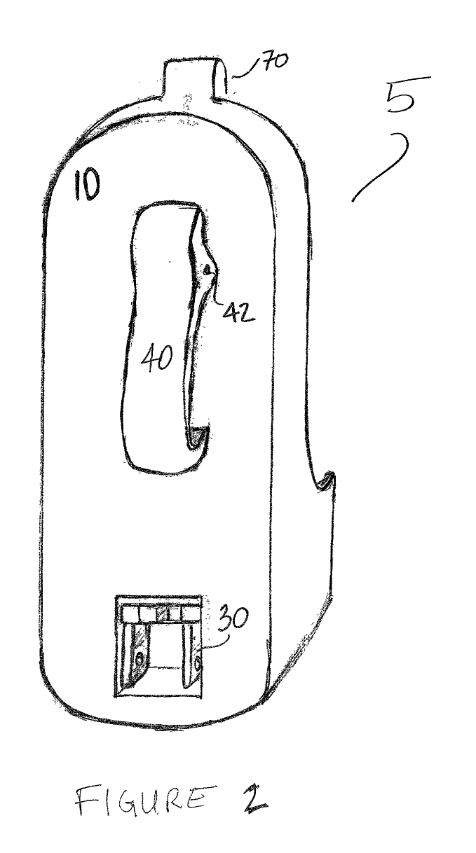

One example of a portable carrier and charger according to this embodiment is shown in FIGS. 1 and 2. FIG. 1 is a perspective view of the front of the portable carrier and charger 5. FIG. 2 is a perspective view of the back of the portable carrier and charger 5.

Housing 10 comprises a plug 30 located on the back of housing 10. Plug 30 is a rotationally moveable two-prong plug and is shown in the concealed position in FIG. 2. Plug 30 is connected to AC/DC adapter circuitry 20 in housing 10 by electrically conductive material (not shown). One skilled in the art might even consider the electrically conductive material not shown as part of AC/DC adapter circuitry 20.

AC/DC adapter circuitry 20 is connected to carrier terminal 50 by electrically conductive material (not shown). Carrier terminal 50 is a slot in a piece of plastic with several copper contacts on one side of the slot.

An attachment device 40 is attached to the back of the portable carrier and charger 5 in FIGS. 1 and 2. Attachment device 40 is a plastic clip with a spring (not shown) connected to housing 10 by pin 42.

Housing 10 of the portable carrier and charger 5 in FIGS. 1 and 2 is a plastic housing configured to hold a portable, handheld electronic device with a rechargeable battery such as a cellular phone. Housing 10 further comprises tab 70 to hold a cellular phone in housing 10 when it is inserted.

A cellular phone with a compatible charger terminal can be carried with portable carrier and charger 5 when it is inserted into housing 10. To charge the battery in the cellular phone, plug 30 is rotated up and inserted into an outlet.

In another embodiment of the invention, the housing further comprises an indicator light. The indicator light is configured to illuminate when a portable, handheld electronic device with a rechargeable battery is in the portable carrier and charger and the battery is charging. Alternatively, the indicator light can be configured to illuminate when the portable carrier and charger is plugged into an outlet with power.

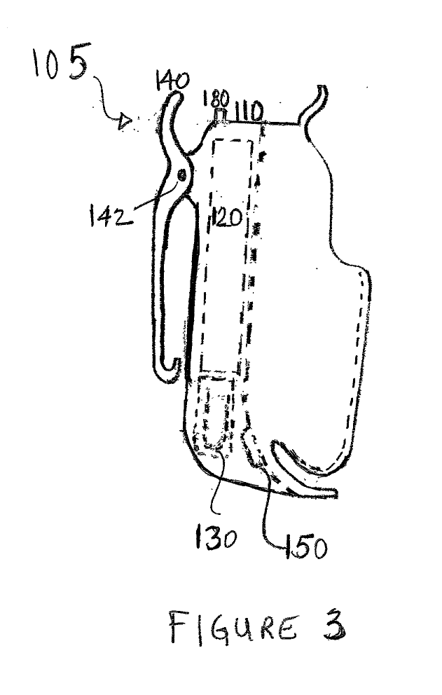

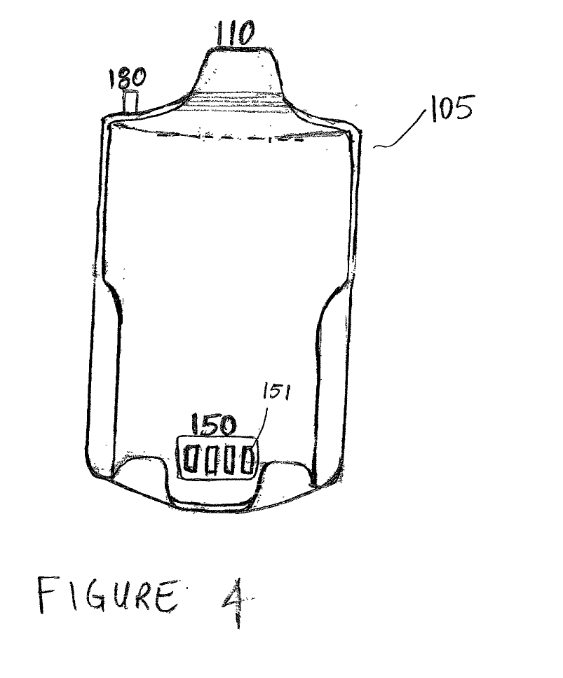

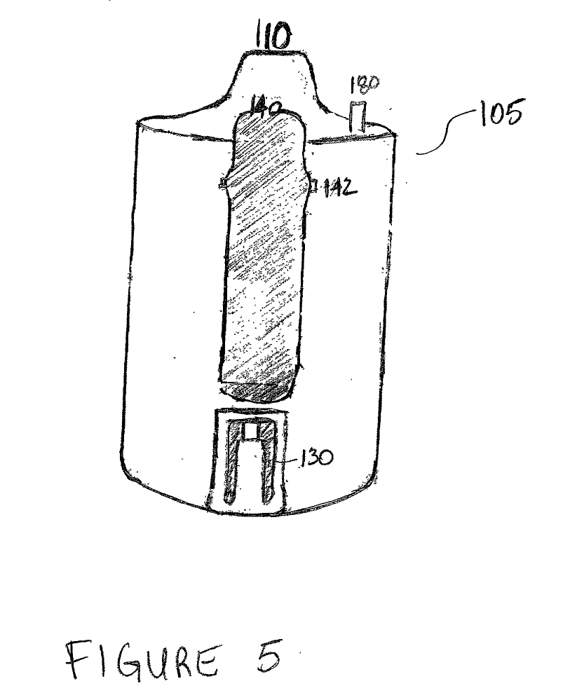

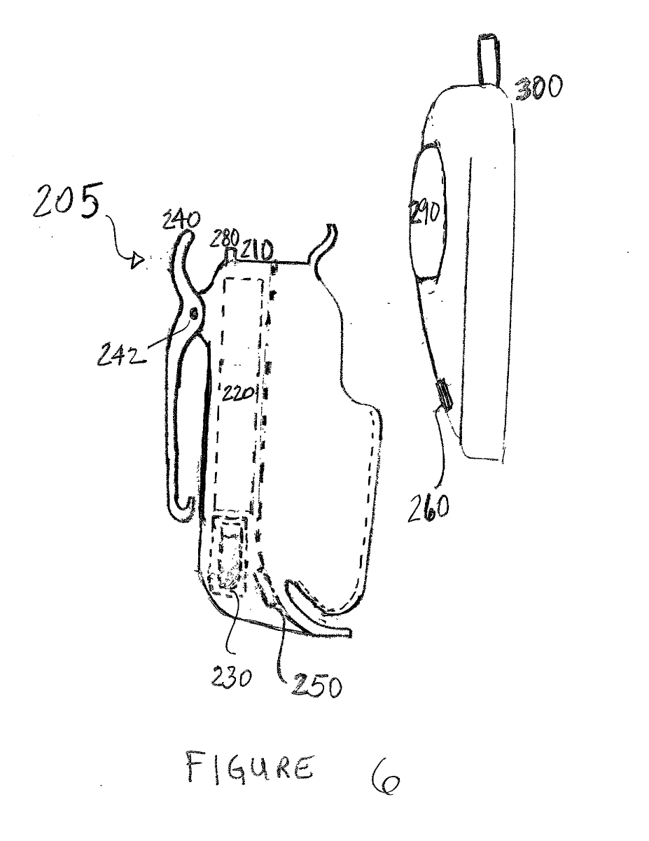

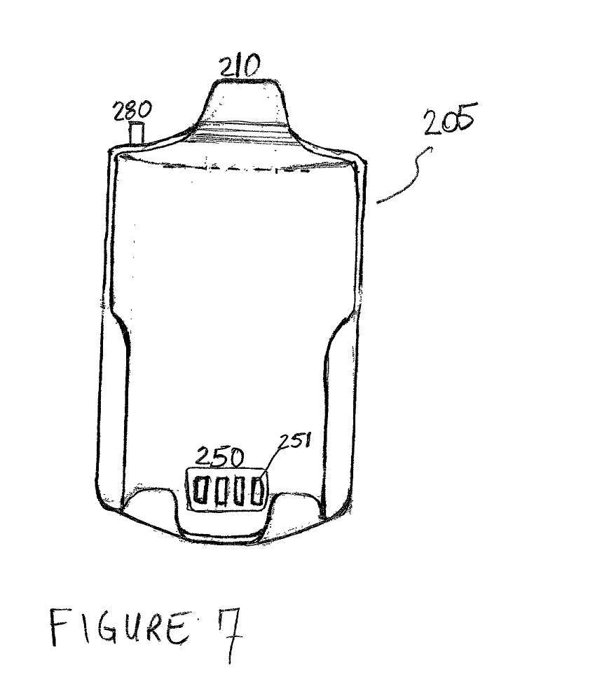

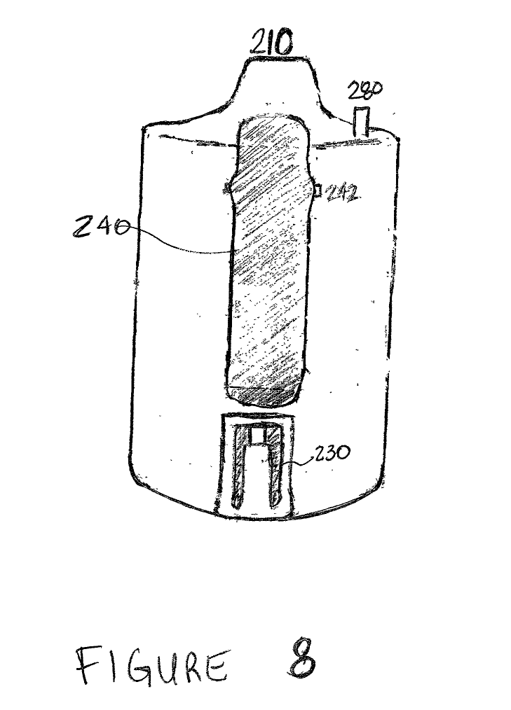

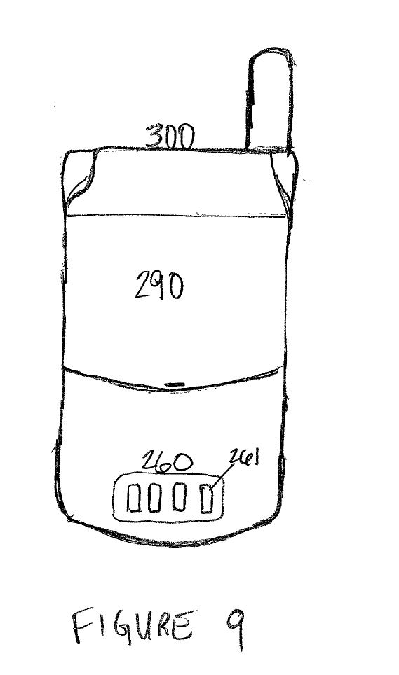

One example of a portable carrier and charger with an indicator light is shown in FIGS. 3-5. FIG. 3 is a side view of a portable carrier and charger. FIG. 4 is a front view of the portable carrier and charger shown in FIG. 3. FIG. 5 is a view of the back of the portable carrier and charger shown in FIG. 3.

Housing 110 of portable carrier and charger 105 is a piece of plastic shaped to hold a cellular phone when it is inserted into housing 110. Housing 110 comprises a plug 130 located in the back of housing 110. Plug 130 is a two-prong plug and is shown in a concealed position. The concealed position avoids having plug 130 protract out of housing 110 when it is not needed. When the user needs to plug the portable carrier and charger 105 into an outlet, plug 130 is rotated out of housing 110 and inserted into an outlet.

Housing 110 further comprises AC/DC adapter circuitry 120 within housing 110, carrier terminal 150, attachment device 140, and indicator light 180.

AC/DC adapter circuitry 120 is connected to plug 130 by electrically conductive material (not shown). AC/DC adapter circuitry 120 is connected to carrier terminal 150 by additional electrically conductive material (not shown). Finally, indicator light 180 is connected to AC/DC adapter circuitry 120 by electrically conductive material (not shown). Again, one skilled in the art might consider all the electrically conductive material as part of AC/DC adapter circuitry 120.

Carrier terminal 150 is located on the front of housing 110. In this example, carrier terminal 150 comprises four copper contacts 151.

Although not required, the example shown in FIGS. 3-5 includes an attachment device 140 connected to housing 110 by pin 142. Attachment device 140 is a plastic clip with a spring (not shown) between housing 110 and attachment device 140. Attachment device 140 is configured to attach to a belt or strap or a pocket lining.

A cellular phone with a compatible charger terminal can be carried in the portable carrier and charger 105 when it is inserted into housing 110. The battery in the cellular phone is charged when plug 130 is rotated and inserted into an outlet.

In the example shown in FIGS. 3-5, the user can slip attachment device 140 over their belt or pocket lining and carry portable carrier and charger 105 with a cellular phone therein without having to hold either of them in their hand. When the user wishes to charge the battery in the cellular phone, the portable carrier and charger 105 is removed from the belt or pocket or bag, plug 130 is rotated out of housing 110 and plug 130 is inserted into an outlet receptacle. The alternating current flows through plug 130 and to AC/DC adapter circuitry 120 where the alternating current and alternating voltage of the alternating power supply is converted into direct current and direct voltage. The direct current then flows through carrier terminal 150 to the charger terminal on the cellular phone and charges the battery.

Another embodiment of the present invention is a portable, handheld, electronic device with a rechargeable battery and a portable carrier and charger for the electronic device. The electronic device comprises a rechargeable battery and a charger terminal for the battery. The charger terminal is connected to the battery by electrically conductive material such that the battery charges when a direct current is applied to the charger terminal.

The portable carrier and charger comprises a housing configured to hold the electronic device when it is inserted by the user, a plug attached to the housing, AC/DC adapter circuitry within the housing and connected to the plug by electrically conductive material, and a carrier terminal on the housing connected to the AC/DC adapter circuitry by electrically conductive material.

Optionally, the portable carrier and charger further comprises an attachment device attached to the housing and an indicator light on the housing and connected to the AC/DC adapter circuitry by electrically conductive material.

The carrier terminal on the housing of the portable carrier and charger and the charger terminal on the electronic device are configured to be compatible with each other so that the two complete an electrically conductive path when they are connected to each other.

One example of a portable, handheld, electronic device with a rechargeable battery and a portable carrier and charger with an indicator light and an attachment device is shown in FIGS. 6-9. FIG. 6 is a side view of the electronic device and the portable carrier and charger. FIG. 7 is a front view of the portable carrier and charger shown in FIG. 6. FIG. 8 is a view of the back of the portable carrier and charger shown in FIG. 6. FIG. 9 is a front view of the electronic device shown in FIG. 6.

Housing 210 of portable carrier and charger 205 is a piece of plastic shaped to hold a cellular phone when it is inserted into housing 210. Housing 210 comprises a plug 230 located in the back of housing 210. Plug 230 is a two-prong plug and is shown in a concealed position. The concealed position avoids having plug 230 protract out of housing 210 when it is not needed. When the user needs to plug the portable carrier and charger 205 into an outlet, plug 230 is rotated out of housing 210 and inserted into an outlet.

Housing 210 further comprises AC/DC adapter circuitry 220 within housing 210, carrier terminal 250, attachment device 240, and indicator light 280. AC/DC adapter circuitry 220 is connected to plug 230 by electrically conductive material (not shown). AC/DC adapter circuitry 220 is connected to carrier terminal 250 by additional electrically conductive material (not shown). Indicator light 280 is connected to AC/DC adapter circuitry 220 by electrically conductive material (not shown). Again, one skilled in the art might consider all the electrically conductive material as part of AC/DC adapter circuitry 220.

Carrier terminal 250 is located on the front of housing 210. In this example, carrier terminal 250 comprises four copper contacts 251.

Although not required, the example shown in FIGS. 6-9 includes an attachment device 240 connected to housing 210 by pin 242. Attachment device 240 is a plastic clip with a spring (not shown) between housing 210 and attachment device 240. Attachment device 240 is configured to attach to a belt or strap or a pocket lining.

Cellular phone 300 comprises charger terminal 260 and rechargeable battery 290. Cellular phone 300 can be carried in the portable carrier and charger 205 when it is inserted into housing 210. Battery 290 in cellular phone 300 is charged when plug 230 is rotated and inserted into an outlet.

In the example shown in FIGS. 6-9, the user can slip attachment device 240 over their belt or pocket lining and carry portable carrier and charger 205 with cellular phone 300 therein without having to hold either of them in their hands. When the user wishes to charge battery 290, the portable carrier and charger 205 is removed from the belt or pocket or bag, plug 230 is rotated out of housing 210 and plug 230 is inserted into an outlet receptacle. The alternating current flows through plug 230 and to AC/DC adapter circuitry 220 where the alternating current and alternating voltage of the alternating power supply is converted into direct current and direct voltage. The direct current then flows through the copper contacts 251 on carrier terminal 250 to the connected copper contacts 261 on charger terminal 260 and then to battery 290.

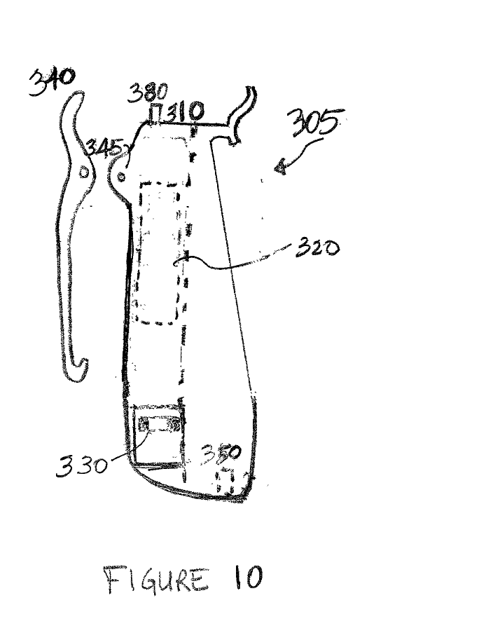

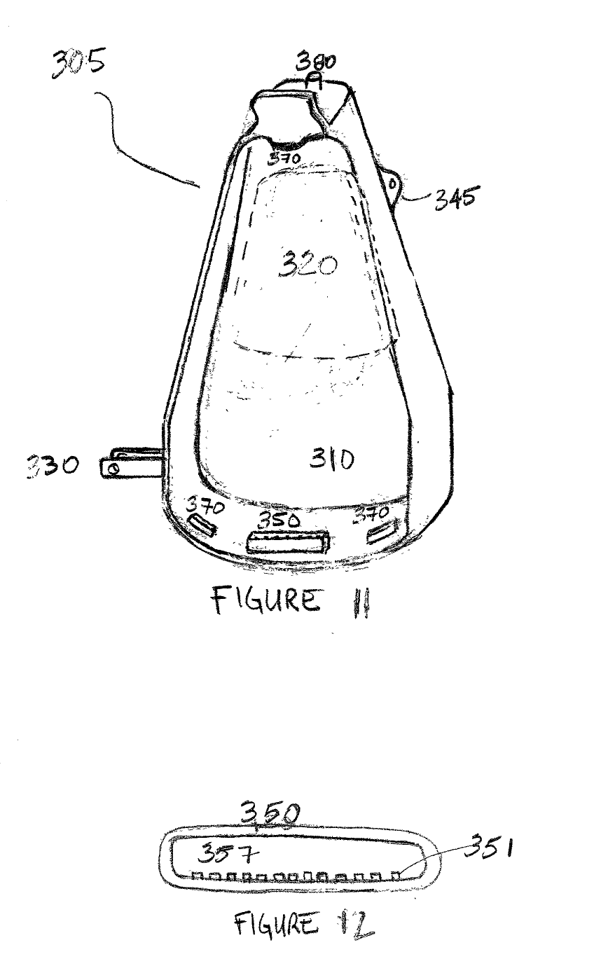

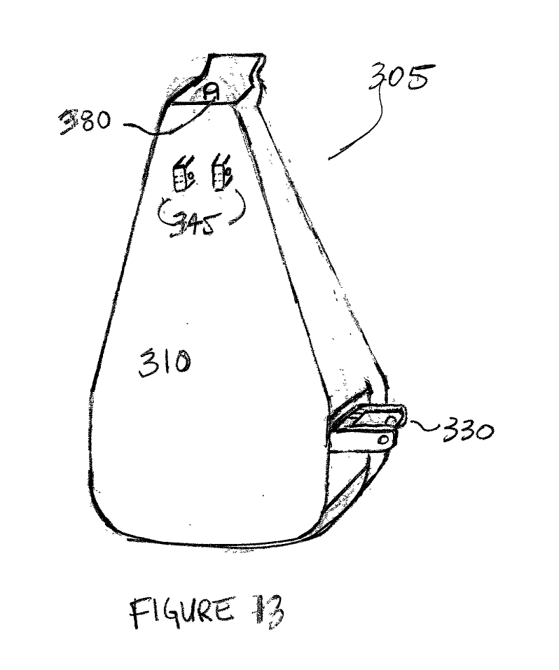

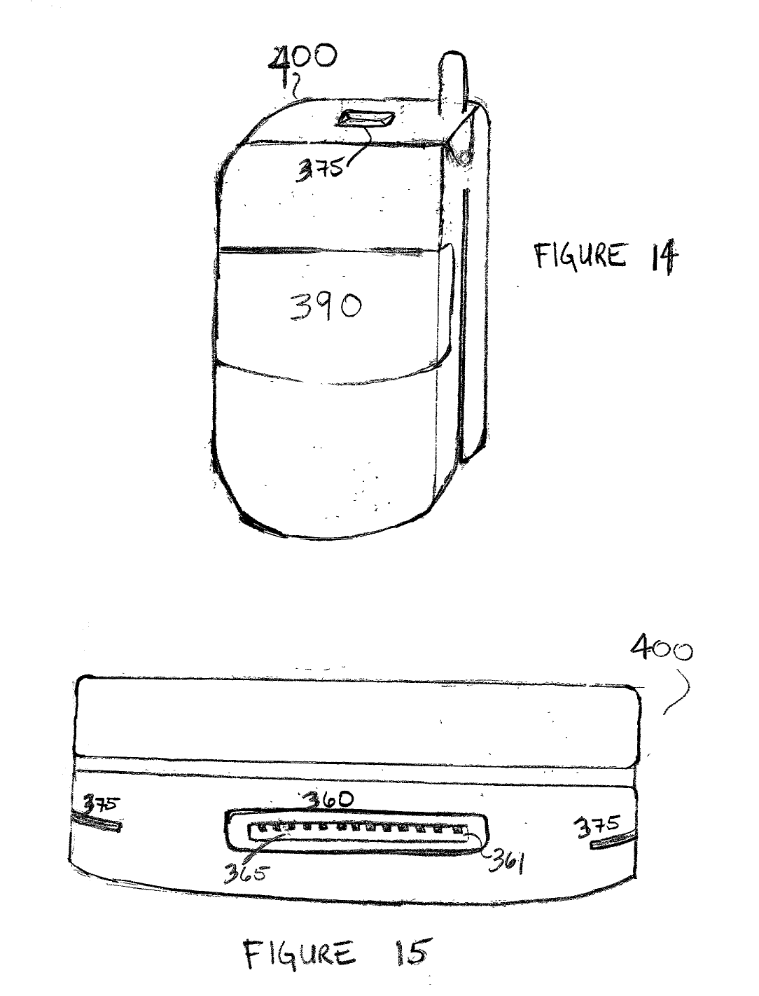

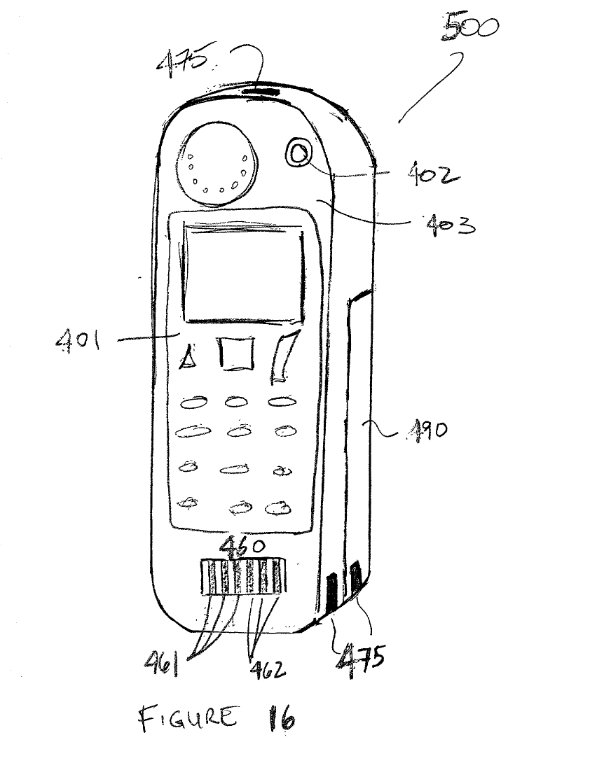

Another example of an embodiment of the invention is shown in FIGS. 10-15. FIG. 10 is a side view of a portable carrier and charger. FIG. 11 is a perspective view of the front of the portable carrier and charger shown in FIG. 10. FIG. 12 is a top view of the carrier terminal on the portable carrier and charger shown in FIG. 10. FIG. 13 is a perspective view of the back of the carrier and charger shown in FIG. 10. FIG. 14 is a perspective view of the front of a cellular phone in a closed position. FIG. 15 is a view of the bottom of the cellular phone shown in FIG. 14.

The portable carrier and charger 305 comprises housing 310, AC/DC adapter circuitry 320, plug 330, tabs 345 for attachment device 340, carrier terminal 350 with slot 357 and copper contacts 351, and tabs 370. The removable attachment device 340 is shown removed from housing 310. The connecting tabs 345 for holding attachment device 340 are shown on housing 310. The removable pin for attaching attachment device 340 to tabs 345 is not shown.

Plug 330 is shown in a lifted position ready for insertion into an outlet receptacle. AC/DC adapter circuitry 320 is shown hidden within housing 310. This example also includes an indicator light 380 on housing 310.

Carrier and charger 305 includes tabs 370 on housing 310 that fit into slots 375 on cellular phone 400 when it is inserted into housing 310. Tabs 370 provide a method for holding cellular phone 400 in housing 310. Carrier terminal 350 is a board type connector comprising a slot 357 and copper contacts 351.

Cellular phone 400 has slots 375 to receive tabs 370 of portable carrier and charger 305 when cellular phone 400 is placed in housing 310. Similarly, charger terminal 360 comprises board 365 and copper contacts 361. When cellular phone 400 is inserted into housing 310, board 365 slips into slot 357 in carrier terminal 350. The copper contacts 361 on board 365 connect to the copper contacts 351 in slot 357 of the carrier terminal 350 and an electrically conductive path is created between plug 330 and battery 390.

Plug 330 is located on the side of portable carrier and charger 305. Such a configuration avoids interference with attachment device 340 when it is attached to housing 310. This configuration also allows for a smaller portable carrier and charger 305 if attachment device 340 is about the same size as cellular phone 400.

The invention is not limited to embodiments where the carrier terminal and the charger terminal are always in contact when a portable, handheld electronic device with a rechargeable battery is in the housing. Other embodiments are included where the electronic device can be placed in the housing in at least two positions so that the carrier terminal does not have to be in contact with the charger terminal when in the housing.

An even further embodiment of the invention incorporates the plug into the portable, handheld, electronic device. When the electronic device is in the portable carrier and charger and the plug on the electronic device is inserted into an outlet, current flows from the plug on the electronic device, through electrically conductive material within the electronic device and to a first set of contacts on the charger terminal.

The charger terminal in this embodiment has two sets of contacts, one for conducting alternating current and a second for conducting direct current. The alternating current flows through the charger terminal and the connecting contacts on the carrier terminal of the portable carrier and charger and into the AC/DC adapter circuitry. The converted current and voltage then flows back to a second set of contacts on the carrier terminal and through a second set of contacts on the charger terminal that are connected to the battery for charging. Thus, in this embodiment, both the carrier terminal and the charger terminal include two distinct sets of contacts, or pins, or boards with metal contacts. The first pair conduct alternating current from the electronic device to the portable carrier and charger and the second pair conduct direct current from the portable carrier and charger to the electronic device.

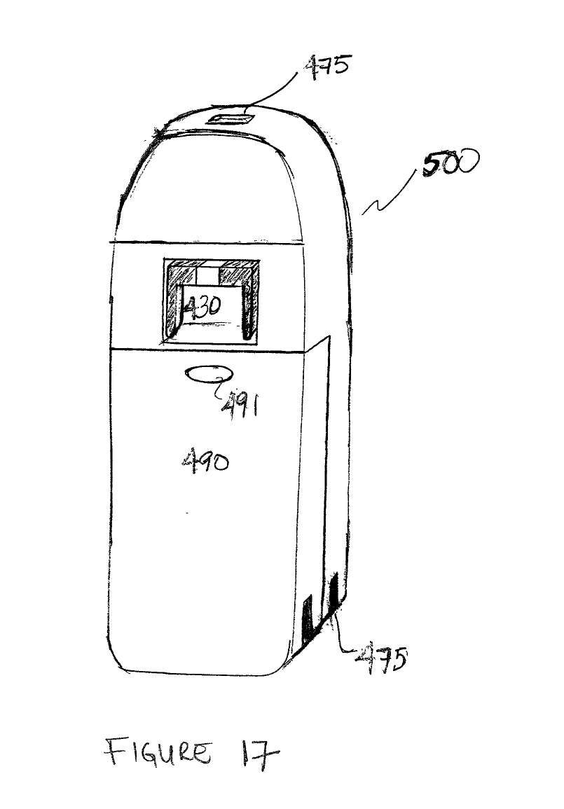

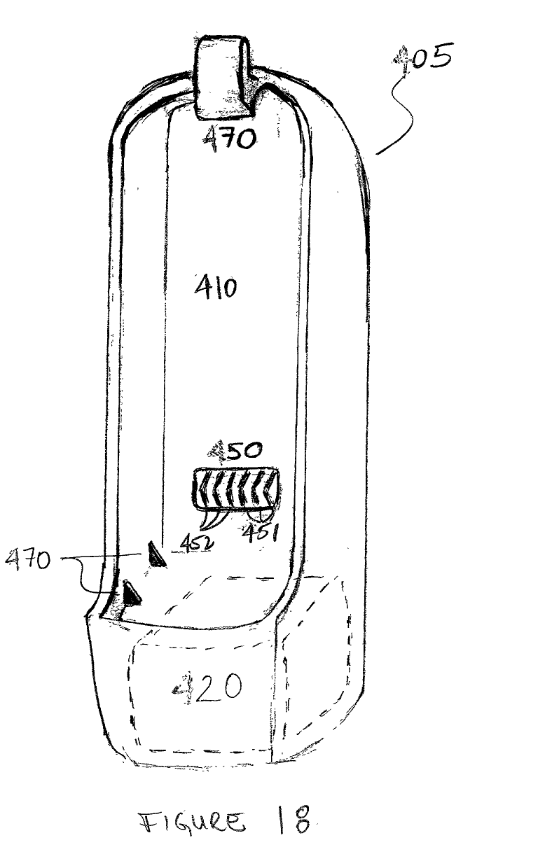

An example is shown in FIGS. 16-18. FIG. 16 is a perspective view of the front of a cellular phone. FIG. 17 is a perspective view of the back of the cellular phone shown in FIG. 16. FIG. 18 is a perspective view of the front of a portable carrier and charger.

Cellular phone 500 comprises button area 401 and power button 402 in faceplate 403, slots 475, charger terminal 460 comprising copper contacts 461 and 462, battery 490 with release button 491, and plug 430. Plug 430 is shown in a concealed position. Battery 490 is removable by pushing button 491.

Carrier and charger 405 comprises housing 410, AC/DC adapter circuitry 420, carrier terminal 450 comprising copper contacts 451 and 452, and tabs 470. Tabs 470 are configured to slide into slots 475 on cellular phone 500 when it is inserted into housing 410. Similarly, copper contacts 461 and 462 on charger terminal 460 connect to copper contacts 451 and 452 on carrier terminal 450 when cellular phone 500 is inserted into the housing with battery 490 facing out of housing 410. AC/DC adapter circuitry 420 is shown hidden in housing 410.

In this example, cellular phone 500 can be inserted into housing 405 in two possible positions (face out or face in). One with carrier terminal 450 connected to charger terminal 460 and another where they are not connected to each other. The user can place cellular phone 500 in housing 405 in either position for carrying the cellular phone 500. To charge battery 490, cellular phone 500 must be place in housing 410 such that the carrier terminal 450 makes contact with the charger terminal 460.

When plug 430 is inserted into an outlet receptacle with carrier terminal 450 in contact with charger terminal 460, alternating current flows from plug 430, through electrically conductive material in cellular phone 500, to copper contacts 461 on charger terminal 460. The alternating current then flows through the connecting copper contacts 451 on carrier terminal 450 and to the AC/DC adapter circuitry 420 via electrically conductive material.

The direct current and direct voltage from the AC/DC adapter circuitry 420, flows to copper contacts 452 on carrier terminal 450 via different electrically conductive material and is conducted through copper contacts 462 on charger terminal 460 to battery 490.

Alternatively, cellular phone 500 and carrier and charger 405 could separate the two sets of contacts on each terminal onto two separate terminal to create a greater distance of separation between the alternating current contacts and the direct current contacts.

I claim:

1. A portable apparatus for carrying a portable, handheld, electronic device with a rechargeable battery and for charging the electronic device's battery, the portable apparatus comprising:
a housing configured to hold an electronic device with a rechargeable battery;
a plug attached to said housing;
AC/DC adapter circuitry within said housing connected to said plug by electrically conductive material, wherein said AC/DC adapter circuitry converts alternating current and alternating voltage from an alternating power supply into direct current and direct voltage; and
a carrier terminal on said housing connected to said AC/DC adapter circuitry by electrically conductive material, wherein said carrier terminal is configured to connect to a charger terminal on the electronic device when the electronic device is placed within said housing;
whereby the battery in the electronic device is charged when said plug is inserted into an outlet and the electronic device is in said housing.

2. The portable apparatus of claim 1, further comprising an attachment device attached to said housing.

3. The portable apparatus of claim 2, wherein said attachment device is at least one from the group consisting of a strap, buckle, clip, slot, velcro, hinged clip, spring and a magnet.

4. The portable apparatus of claim 1, wherein said plug is moveable within said housing.

5. The portable apparatus of claim 4, wherein said plug is rotationally moveable within said housing.

6. The portable apparatus of claim 4, wherein said plug is configured to be positioned in at least one of an outward position and an inward position relative to said housing and said plug is concealable within said housing.

7. The portable apparatus of claim 1, further comprising an indicator light attached to said housing, said indicator light connected to said AC/DC adapter circuitry by electrically conductive material and configured to indicate one of when the battery in the electronic device is charging and when said AC/DC adapter circuitry is powered.

8. The portable apparatus of claim 1, wherein said housing is at least one material from the group consisting of a plastic, a metal, a composite, and a fiberglass.

9. The portable apparatus of claim 1, wherein said carrier terminal is at least one from the group consisting of at least one metal contact, at least one pin connector and at least one board type connector with metal contacts.

10. The portable apparatus of claim 1, wherein said housing is configured to hold at least one from the group consisting of a cellular phones, a personal digital assistant, an organizer, and a daily planner.

11. A portable apparatus for carrying a cellular phone and charging the cellular phone's battery, the portable apparatus comprising:
a housing configured to hold a cellular phone with a rechargeable battery;
an attachment device attached to said housing;
a plug attached to said housing;
AC/DC adapter circuitry within said housing connected to said plug by electrically conductive material, wherein said AC/DC adapter circuitry converts alternating current and alternating voltage from an alternating power supply into direct current and direct voltage; and
a carrier terminal on said housing connected to said AC/DC adapter circuitry by electrically conductive material, said carrier terminal configured to connect to a charger terminal on the cellular phone when the cellular phone is placed within said housing;
whereby the battery in the cellular phone is charged when said plug is inserted into an outlet and the cellular phone is in said housing.

12. The portable apparatus of claim 11, wherein said attachment device is one of fixedly attached to said housing and removable from said housing.

13. The portable apparatus of claim 11, further comprising an indicator light attached to said housing, said indicator light connected to said AC/DC adapter circuitry by electrically conductive material and configured to indicate one of when the battery in the cellular phone is charging and when said AC/DC adapter circuitry is powered.

14. The portable apparatus of claim 11, wherein said attachment device is at least one from the group consisting of a strap, buckle, clip, slot, velcro, hinged clip, spring and a magnet.

15. The portable apparatus of claim 11, wherein said housing is at least one material from the group consisting of a plastic, a metal, a composite, and a fiberglass.

16. The portable apparatus of claim 11, wherein said carrier terminal is at least one from the group consisting of at least one metal contact, at least one pin connector and at least one board type connector with metal contacts.

17. The portable apparatus of claim 11, wherein said plug is moveable and concealable within said housing and configured to be positioned in at least one of an outward position and an inward position relative to said housing.

18. A cellular phone and a portable apparatus for carrying the cellular phone and charging the cellular phone's battery comprising:
a cellular phone comprising a rechargeable battery and a charger terminal for said rechargeable battery; and
a portable apparatus comprising:
a housing configured to hold said cellular phone;
a plug attached to said housing;
AC/DC adapter circuitry within said housing connected to said plug by electrically conductive material, wherein said AC/DC adapter circuitry converts alternating current and alternating voltage from an alternating power supply into direct current and direct voltage; and
a carrier terminal on said housing connected to said AC/DC adapter circuitry by electrically conductive material, wherein said carrier terminal is configured to connect to said charger terminal on said cellular phone when said cellular phone is placed within said housing;
whereby said battery of said cellular phone is charged when said plug is inserted into an outlet and said cellular phone is in said housing.

19. The cellular phone and portable apparatus of claim 18, further comprising an attachment device attached to said housing.

20. The cellular phone and portable apparatus of claim 19, wherein said attachment device is at least one from the group consisting of a strap, buckle, clip, slot, velcro, hinged clip, spring and a magnet.

21. The cellular phone and portable apparatus of claim 18, further comprising an indicator light attached to said housing, said indicator light connected to said AC/DC adapter circuitry by electrically conductive material and configured to indicate one of when said battery in said cellular phone is charging and when said AC/DC adapter circuitry is powered.

22. The cellular phone and portable apparatus of claim 18, wherein said housing is at least one material from the group consisting of a plastic, a metal, a composite, and a fiberglass.

23. The cellular phone and portable apparatus of claim 18, wherein said carrier terminal and said charger terminal are each at least one from the group consisting of at least one metal contact, at least one pin connector and at least one board type connector with metal contacts.

24. The cellular phone and portable apparatus of claim 18, wherein said plug is moveable and concealable within said housing and configured to be positioned in at least one of an outward position and an inward position relative to said housing.

25. A cellular phone and a portable apparatus for carrying the cellular phone and charging the cellular phone's battery comprising:
a cellular phone comprising:
a rechargeable battery;
a charger terminal on said cellular phone comprising a first set and a second sets of contacts, said second set of contacts connected to said battery by electrically conductive material wherein said battery is charged when a direct current is applied to said second set of contacts on said charger terminal; and
a plug on said cellular phone wherein said plug is concealable within said cellular phone and said plug is connected to said first set of contacts on said charger terminal by electrically conductive material; and
a portable apparatus comprising:
a housing configured to hold said cellular phone;
an attachment device attached to said housing;
AC/DC adapter circuitry within said housing, wherein said AC/DC adapter circuitry converts alternating current and alternating voltage from an alternating power supply into direct current and direct voltage; and
a carrier terminal on said housing comprising a first set and a second sets of contacts, said first set of contacts connected to said AC/DC adapter circuitry by electrically conductive material, said second set of contacts also connected to said AC//DC adapter circuitry by electrically conductive material, said first set and said second set of contacts on said carrier terminal configured to electrically connect to said first set and said second set of contacts on said charger terminal when said cellular phone is placed within said housing;
whereby said battery of said cellular phone is charged when said plug is inserted into an outlet and said cellular phone is in said housing.

26. The cellular phone and portable apparatus of claim 25, further comprising an indicator light attached to said housing, said indicator light connected to said AC/DC adapter circuitry by electrically conductive material and configured to indicate one of when said battery in said cellular phone is charging and when said AC/DC adapter circuitry is powered.

27. The cellular phone and portable apparatus of claim 25, wherein said attachment device is at least one from the group consisting of a strap, buckle, clip, slot, velcro, hinged clip, spring and a magnet.

28. The cellular phone and portable apparatus of claim 25, wherein said housing is at least one material from the group consisting of plastic, metal, composites, and fiberglass.

29. The cellular phone and portable apparatus of claim 25, wherein said carrier terminal and said charger terminal are each at least one from the group consisting of at least one metal contact, at least one pin connector and at least one board type connector with metal contacts.

30. A portable, handheld, electronic device with a rechargeable battery and a portable apparatus for carrying the electronic device and for charging the electronic device's battery comprising:
a portable, handheld, electronic device comprising a rechargeable battery and a charger terminal for said battery; and
a portable apparatus comprising:
a housing composed of at least one material from the group consisting of a plastic, a metal, a composite, and a fiberglass;
an attachment device attached to said housing;
a plug rotationally attached to said housing;
AC/DC adapter circuitry within said housing connected to said plug by electrically conductive material, wherein said AC/DC adapter circuitry converts alternating current and alternating voltage from an alternating power supply into direct current and direct voltage; and
a carrier terminal on said housing connected to said AC/DC adapter circuitry by electrically conductive material said carrier terminal configured to electrically connect to said charger terminal on said electronic device when said electronic device is placed within said housing;
whereby said battery of said electronic device is charged when said plug is inserted into an outlet and said electronic device is in said housing.

31. The electronic device and portable apparatus of claim 30, wherein said electronic device is at least one from the group consisting of a cellular phone, a personal digital assistant, an organizer, and a daily planner.

32. The electronic device and portable apparatus of claim 30, further comprising an indicator light attached to said housing, said indicator light electrically connected to said AC/DC adapter circuitry and configured to indicate one of when said battery in said electronic device is charging and when said AC/DC adapter circuitry is powered.

33. The electronic device and portable apparatus of claim 30, wherein said carrier terminal and said charger terminal are each at least one from the group consisting of at least one metal contact, at least on pin connector and at least one board type connector with metal contacts.

34. The electronic device and portable apparatus of claim 30, wherein said attachment device is at least one from the group of a strap, buckle, clip, slot, velcro, hinged clip, spring and a magnet.
